(19) United States
(12) Patent Application Publication
(10) Pub. No.: US 2007/0236518 A1
(43) Pub. Date: Oct. 11, 2007

(54) HYSTERETIC LED DRIVER WITH LOW END LINEARIZATION

(76) Inventors: Leonard De Oto, Springfield, OH (US); William H. Tyson, Urbana, OH (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/278,528

(22) Filed: Apr. 3, 2006

(51) Int. Cl. G09G 5/10

(52) U.S. Cl. 345/691

(57) ABSTRACT

Systems and methods for smoothing out visual effects of Light Emitting Diodes (LEDs). An example circuit includes one or more LEDs, a hysteretic controller circuit, and a linearization circuit. The hysteretic controller circuit supplies current to the LEDs when a Pulse Width Modulation (PWM) signal is in a first state and the linearization circuit drives the current supplied by the hysteretic controller circuit to an off state when the PWM signal transitions to a second state.

### BACKGROUND OF THE INVENTION

When backlighting Liquid Crystal Displays (LCDs) at a low luminance level using a recirculating current type controller, the brightness with respect to Pulse Width Modulation (PWM), while monotonically increasing, exhibits flat regions that make control difficult. The flat regions are created by the use of the recirculating current. The placement of these flat regions can vary from unit to unit.

The recirculating current method is the most efficient method to power a Light Emitting Diode (LED). The current is ramped up through an inductor, storing energy, when a switch is closed. When the switch is opened, the energy stored in the inductor is recirculated through the LEDs (typically with a free-wheeling diode). If termination occurs when the switch is already off, the level of brightness is the same whether the point of termination is just after the switch turned off, or just before it is about to turn back on; thus exhibiting flat regions of brightness.

Therefore, there exists a need to linearize the flat regions to smooth the visual effects especially in dimming situations.

### BRIEF SUMMARY OF THE INVENTION

The present invention provides systems and methods for smoothing the visual effects of Light Emitting Diodes (LEDs). An example circuit formed in accordance with an embodiment with the present invention includes one or more LEDs, a hysteretic controller circuit, and a linearization circuit. The hysteretic controller circuit supplies current to the LEDs when a Pulse Width Modulation (PWM) signal is in a first state and the linearization circuit drives the current supplied by the hysteretic controller circuit to an off state when the PWM signal transitions to a second state.

In one aspect of the invention, the linearization circuit includes an N channel MOSFET transistor. The linearization circuit includes an inverter for inverting the PWM signal and sending the inverted PWM signal to a gate of the transistor. The hysteretic controller circuit includes an inductor and the N channel MOSFET transistor includes a drain that is connected between one end of the inductor and an anode of the one or more LEDs.

### BRIEF DESCRIPTION OF THE SEVERAL VIEWS OF THE DRAWING

The preferred and alternative embodiments of the present invention are described in detail below with reference to the following drawings.

FIG. 1 illustrates a block diagram of a device formed in accordance with an embodiment of the present invention;

FIG. 2 illustrates a detailed circuit diagram of the device shown in FIG. 1;

FIG. 3 illustrates a graph of current through an LED that reacts in accordance with an embodiment of the present invention relative to a pulse width modulation signal; and

FIG. 4 illustrates a graph of examples of voltages across a sense resistor, indicative of LED current, in accordance with an embodiment of the present invention.

### DETAILED DESCRIPTION OF THE INVENTION

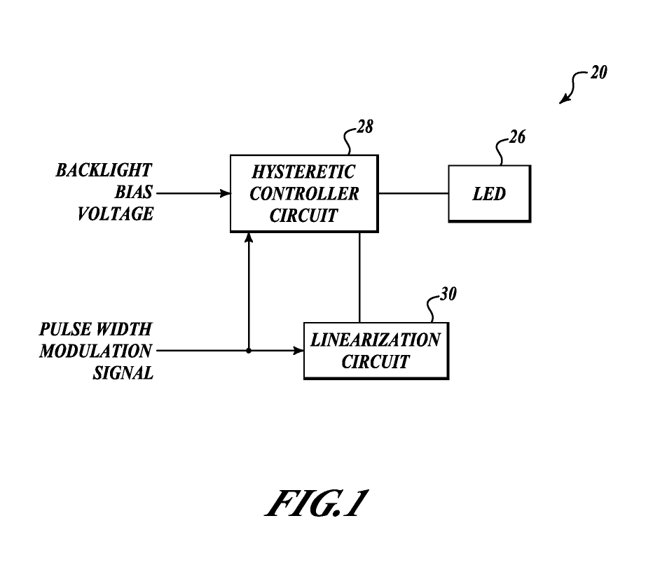

FIG. 1 illustrates a block diagram of an example circuit 20 for hysteretically driving one or more Light Emitting Diodes (LEDs) 26 while employing low-end linearization. The circuit 20 includes a hysteretic controller circuit 28 that controls the current to one or more LEDs 26 according a received Pulse Width Modulation (PWM) signal and a backlight bias voltage (VIN). The backlight bias voltage is preferably controlled by a user operating a switch, which allows the user to set a dimming value for the LEDs 26 with the PWM signal. An example of the hysteretic controller circuit 28 is described in U.S. patent application Ser. No. 11/069,298, filed Mar. 1, 2005 and Ser. No. 11/181,815 filed Jul. 15, 2005, the contents of which are hereby incorporated by reference.

The circuit 20 also includes a linearization circuit 30 that provides better control of the brightness level especially at low luminance values. The linearization circuit 30 operates in accordance with the received PWM signal.

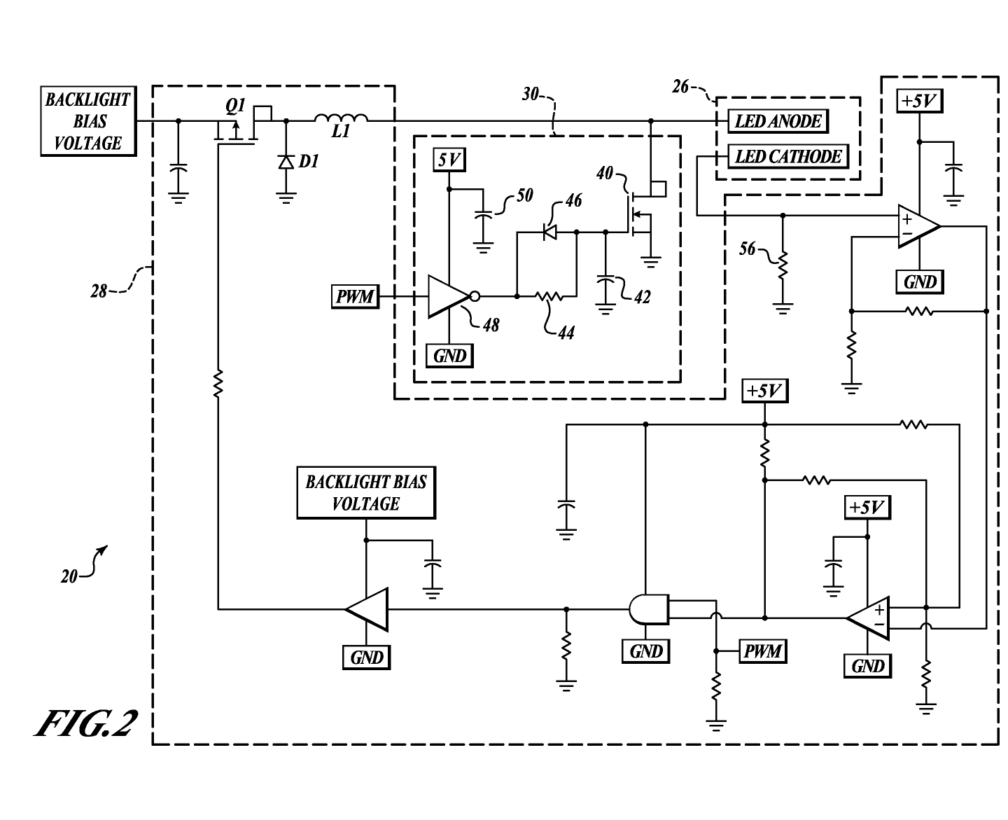

FIG. 2 illustrates an example circuit diagram of the circuit 20 from FIG. 1. The contents and the function of the components of the hysteretic controller circuit 28 are described by example in the co-pending applications described above. The linearization circuit 30 includes an N channel MOSFET transistor 40 that has a drain that is coupled between an inductor L1 of the hysteretic controller circuit 28 and an anode of the LED 26. The source of the transistor 40 is connected to ground and the gate of the transistor 40 is connected to a first capacitor 42, a first end of a resistor 44, and the anode of diode 46. A second side of the capacitor 42 is coupled to ground. The cathode of the diode 46 is coupled to second side of the resistor 44 and to an output of an inverter 48. The inverter 48 receives the PWM signal at its input and receives a supply voltage. The supply voltage is also connected to a first end of a capacitor 50 and a second end of the capacitor 50 is connected to ground.

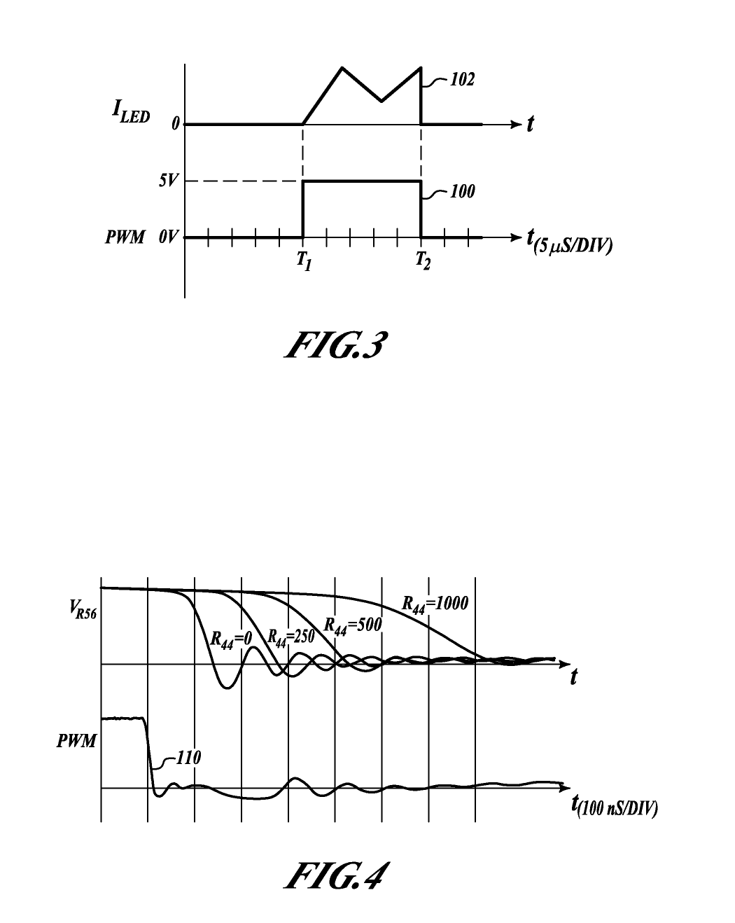

When the PWM signal is high, the hysteretic controller circuit 28 turns a transistor Q1 on and off to provide a current (I_{LED}) through the LEDs 26 such as is shown in FIG. 3. When the transistor Q1 is off, the controller circuit 28 recirculates the current in the inductor L1 through the LEDs 26 using diode D1. When the PWM signal goes low, the transistor Q1 is inhibited from turning back on and the transistor 40 turns on. When the transistor 40 turns on a path to ground is provided for the recirculating current of the inductor L1. Thus, the LEDs 26 turn off immediately, instead of when the energy in the inductor L1 is dissipated through them. The resistor 44 and capacitor 42 are provided to create a soft turn on for the transistor 40 for reducing Electromagnetic Interference (EMI) and prevent shoot-through should transistor Q1 be on at the instant the PWM signal goes low. The diode 46 is provided to create a fast turn off of the transistor 40 so as to minimize or eliminate any potential shoot-through effects with both transistors 40 and Q1 on at the same time.

FIG. 3 illustrates a time graph when the LEDs 26 are in a dimmed mode of operation. In this dimmed mode of operation, the PWM signal 100 cycles on and off over a short cycle. In this example, the PWM signal 100 is on for approximately 25 μS. During the time in which the PWM signal 100 is high, or in this example, 5 volts, the hysteretic controller circuit 28 produces an LED current 102 as shown. When the PWM signal 100 goes low at T2, the linearization circuit 30 causes the LED current to instantaneously or near instantaneously shunt to zero. In another embodiment, the linearization circuit 30 is designed to shunt the energy of the inductor L1 when the PWM signal 100 cycles to an off state.

FIG. 4 illustrates another timing diagram illustrating a PWM signal 10 and a plurality of graphs of voltage VR56 across the sense resistor 56 of the hysteretic controller circuit 28 when different values for the resistor 44 are used. The larger the value that is used for the resistor 44, the longer it will take for the voltage VR56 to drop to zero across the resistor 56. In this example, it will take approximately 300 nanoseconds (nS) for the voltage V_{R56} to drop to zero when the value of the resistor 44 is equal to 250 ohms from the time the PWM signal 110 goes low.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A Light Emitting Diode (LED) circuit comprising:
one or more LEDs;
a hysteretic controller circuit for supplying current to the one or more LEDs when a Pulse Width Modulation (PWM) signal is in a first state; and
a shunt element for driving the current supplied by the hysteretic controller circuit to an off state when the PWM signal transitions to a second state.

2. The circuit of claim 1, wherein the shunt element includes an N channel MOSFET transistor.

3. The circuit of claim 2, wherein the shunt element includes an inverter for inverting the PWM signal and sending the inverted PWM signal to a gate of the transistor.

4. The circuit of claim 2, wherein the hysteretic controller circuit includes an inductor and the N channel MOSFET transistor includes a drain that is connected between one end of the inductor and an anode of the one or more LEDs.

5. The circuit of claim 1, wherein the first state of the PWM signal is a first voltage value and the second state is a second voltage value that is lower that the first voltage value.

6. The circuit of claim 1, wherein the first state of the PWM signal is a first voltage value and the second state is a second voltage value that is higher that the first voltage value.

7. A method comprising:
supplying current to one or more Light Emitting Diodes (LEDs) using a hysteretic controller circuit when a Pulse Width Modulation (PWM) signal is in a first state; and
driving a residual current produced by an inductor of the hysteretic controller circuit to an off state when the PWM signal transitions to a second state.

8. The method of claim 7, wherein driving is performed by a linearization circuit having an N channel MOSFET transistor.

9. The method of claim 8, further comprising:
inverting the PWM signal; and
sending the inverted PWM signal to a gate of the transistor.

10. The method of claim 8, wherein the hysteretic controller circuit includes an inductor and the N channel MOSFET transistor includes a drain that is connected between one end of the inductor and an anode of the one or more LEDs.

11. The method of claim 7, wherein the first state of the PWM signal is a first voltage value and the second state is a second voltage value that is lower that the first voltage value.

12. The method of claim 7, wherein the first state of the PWM signal is a first voltage value and the second state is a second voltage value that is higher that the first voltage value.
